(19) United States
(12) Patent Application Publication
(10) Pub. No.: US 2026/0003749 A1
(43) Pub. Date: Jan. 1, 2026

(54) CONFIGURABLE DIE-TO-DIE LANE REPAIR IN MULTI-DIE SYSTEMS COUPLED USING LINK MACROS

(71) Applicant: Microsoft Technology Licensing, LLC, Redmond, WA (US)

(72) Inventors: Michael Raymond TROMBLEY, Cary, NC (US); Charles Walter BOECKER, Ames, IA (US); Ravi SHIVNARAINE, Pickering (CA); Eric Douglas GROEN, Ankeny, IA (US); Simon Shichi LI, Cupertino, CA (US)

(21) Appl. No.: 18/754,807

(22) Filed: Jun. 26, 2024

(51) Int. Cl. G06F 11/20

(52) U.S. Cl. CPC G06F 11/2041; G06F 11/2002

(57) ABSTRACT

Systems and methods for configurable die-to-die lane repair in multi-die systems are described. A multi-die system includes a first die and a second die, each of which comprises modular D2D link macros, where each of the modular D2D link macros has M data lanes. A method for configuring die-to-die lane repair includes forming repair groups having D data lanes spanning M data lanes, or fewer than M data lanes, associated with one or more modular D2D link macros, where D is independently configurable for each repair group. The method further includes, for each one of the repair groups designating R redundant lanes from among the D data lanes, where R is a positive integer independently configurable for each repair group, and where a location of each of the designated redundant lanes within a die floor plan associated with a respective repair group is independently configurable.

### BACKGROUND

Die-to-die (D2D) links are an integral aspect of advanced packaging technologies, including packaging technologies for integrating separate dies into multi-die systems. Example topologies of integrated dies include horizontally integrated dies (e.g., chiplets in a plane) and vertically-integrated dies (e.g., 2.5D, 3D, and silicon bridge topologies). A large monolithic chip, e.g., a system on chip (SoC), can be split into multiple smaller dies, which are referred to as chiplets. Example protocols for interconnecting the dies, including chiplets, in such topologies include Universal Chiplet Interconnect Express (UCIe), Bunch Of Wires (BOW), and OCP's OpenHBI Specification (OHBI).

Die-to-Die (D2D) links are used to integrate portions (located on separate chiplets/dies) of large systems, such as SoCs, into a single system. The bandwidth required from the D2D links across a die edge can be asymmetrical or symmetrical. As an example, a certain application may require more transmit bandwidth than receive bandwidth while another may require the opposite. For example, D2D links from an SoC chiplet to an HBM chiplet may be required to support more bandwidth for read operations relative to the write operations. Current standards (UCIe, BoW, OHBI) for interconnecting dies/chiplets assume symmetrical interfaces with respect to bandwidth.

In many instances, redundant lanes can be provided to address failures in the lanes. Prior solutions offering redundant lanes are inflexible in terms of their ability to address use cases involving different bandwidths across the dies. This is because often the standard topologies (e.g., UCIe, BoW, OHBI) for interconnecting dies/chiplets assume symmetrical interfaces with respect to bandwidth. Such assumptions result in redundant lanes being limited in terms of flexibility and use for scenarios, such as the ones requiring asymmetric bandwidth across the die edge. Accordingly, there is a need for configurable die-to-die lane repair in multi-die systems.

### SUMMARY

In one example, the present disclosure relates to a multi-die system including a first die comprising a first set of modular die-to-die (D2D) link macros. The multi-die system further includes a second die comprising a second set of modular D2D link macros, where each of the first set of modular D2D link macros and the second set of modular D2D link macros has M data lanes, and where M is a positive integer.

The multi-die system may further include repair control logic within the multi-die system: (1) to enable formation of repair groups having D data lanes spanning M, or fewer than M, data lanes associated with one or more modular D2D link macros, where D is a positive integer independently configurable for each repair group, and (2) for each one of the repair groups, to enable designation of R redundant lanes from among the D data lanes, where R is a positive integer independently configurable for each repair group, and where a location of each of the designated redundant lanes within a die floor plan associated with a respective repair group is independently configurable for the respective repair group.

In another example, the present disclosure relates to a method for configuring die-to-die lane repair for a multi-die system having a first die coupled with a second die. The first die may comprise a first set of modular die-to-die (D2D) link macros and the second die may comprise a second set of modular D2D link macros, where each of the first set of modular D2D link macros and the second set of modular D2D link macros has M data lanes, and where M is a positive integer.

The method may include forming repair groups having D data lanes spanning M data lanes, or fewer than M data lanes, associated with one or more modular D2D link macros, where D is a positive integer independently configurable for each repair group. The method may further include for each one of the repair groups designating R redundant lanes from among the D data lanes, where R is a positive integer independently configurable for each repair group, and where a location of each of the designated redundant lanes within a die floor plan associated with a respective repair group is independently configurable.

In yet another example, the present disclosure relates to a method for configuring die-to-die lane repair for lanes between a first die and a second die in a multi-die system. The first die may comprise a first set of modular die-to-die (D2D) link macros. The second die comprises a second set of modular D2D link macros. Each of the first set of modular D2D link macros and the second set of modular D2D link macros has M data lanes, where M is a positive integer.

The method may include forming repair groups having D data lanes spanning M data lanes, or fewer than M data lanes, associated with one or more modular D2D link macros, where D is a positive integer independently configurable for each repair group, and where D is selected based on both a use case associated with the multi-die system and packaging yield properties for the multi-die system obtained from package sorting. The method may further include for each one of the repair groups designating R redundant lanes from among the D data lanes, where R is a positive integer independently configurable for each repair group, where R is selected based on both the use case associated with the multi-die system and the packaging yield properties for the multi-die system obtained from package sorting, and where a location of each of the designated redundant lanes within a die floor plan associated with a respective repair group is independently configurable.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows an example die-to-die (D2D) node for use as part of a multi-die system with modular D2D link macros for enabling configurable die-to-die lane repair;

FIG. 2 shows additional details of a D2D transmit link macro and a D2D receive link macro for use with the D2D node of FIG. 1;

FIG. 3 shows an example multi-die system having D2D nodes with modular D2D link macros for enabling configurable die-to-die lane repair;

FIG. 4 shows a block diagram of an example modular D2D link macro for use with multi-die systems with configurable die-to-die repair;

FIG. 5 shows a block diagram of an example modular D2D transmit link macro for use with multi-die systems with configurable die-to-die repair;

FIG. 6 shows a block diagram of an example modular D2D receive link macro for use with multi-die systems with configurable die-to-die repair;

FIG. 7 shows an example set of modular transmit link macros for use with multi-die systems with configurable die-to-die repair;

FIG. 8 shows an example set of modular receive link macros for use with multi-die systems with configurable die-to-die repair;

FIG. 9 shows an example D2D node illustrating some of the fault scenarios that can occur in multi-die systems;

FIG. 10 shows a set of modular link macros that can have different configurations of die-to-die lane repair;

FIG. 11 shows a set of modular link macros with a repair group to explain the configurability of the die-to-die lane repair;

FIG. 12 shows a logical view of a transmit data path for the repair group of FIG. 11;

FIG. 13 shows a logical view of a receive data path for the repair group of FIG. 11;

FIG. 14 shows a diagram of a set of link macros, including faults within the repair group of FIG. 11, to further explain the configurability of the die-to-die lane repair;

FIG. 15 shows a logical view of a transmit data path for a repair group;

FIG. 16 shows a logical view of a receive data path for a repair group; and

FIG. 17 shows a flowchart of a method for configuring die-to-die lane repair for lanes between a first die and a second die in a multi-die system.

### DETAILED DESCRIPTION

Examples described in this disclosure relate to multi-die systems with modular die-to-die link macros for enabling die-to-die communication. Certain examples further relate to using the modular die-to-die link macros for enabling configurable die-to-die lane repair. Die-to-die (D2D) links are an integral aspect of advanced packaging technologies, including packaging technologies for integrating separate dies into multi-die systems. Example topologies of multi-die systems include horizontally integrated dies (e.g., chiplets in a plane) and vertically-integrated dies (e.g., 2.5D, 3D, and silicon bridge topologies). A large monolithic chip, e.g., a system on chip (SoC), can be split into multiple smaller dies, which are often referred to as chiplets. As used herein the term “die” includes any block of material (e.g., semiconducting material or other types of materials used in manufacturing of integrated circuits on a shared substrate) having integrated circuits, where the die can be packaged. The term “dies” includes chiplets, which are typically smaller than a die.

Die-to-Die (D2D) links are used to integrate portions (located on separate chiplets/dies) of large systems, such as SoCs, into a single system. The bandwidth required from the D2D links across a die edge can be asymmetrical or symmetrical. As an example, a certain application may require more transmit bandwidth than receive bandwidth while another may require the opposite. For example, depending upon the application context, D2D links from an SoC die to an HBM stack of dies may be required to support more bandwidth for the read operations relative to the write operations, or conversely less bandwidth for the read operations relative to the write operations. Example industry standard protocols for interconnecting the dies include Universal Chiplet Interconnect Express (UCIe), Bunch Of Wires (BOW), and OCP's OpenHBI Specification (OHBI). Such standards offer the benefits that are typically associated with industry standardization but they are not flexible in terms of their use in disparate bandwidth scenarios, as noted earlier. The current standards (UCIe, BoW, OHBI) for interconnecting dies assume symmetrical interfaces with respect to bandwidth.

In many instances, redundant lanes can be provided to address failures in the lanes interconnecting the dies. Prior solutions offering redundant lanes are inflexible in terms of their ability to address use cases involving different bandwidths across the dies. This is because often the standard topologies (e.g., UCIe, BoW, OHBI) for interconnecting dies assume symmetrical interfaces with respect to bandwidth. Such assumptions result in redundant lanes being limited in terms of flexibility and use for scenarios, such as the ones requiring asymmetric bandwidth across the die edge. Accordingly, there is a need for configurable die-to-die lane repair in multi-die systems.

Examples described herein relate to the die-to-die link macros (transmit and receive) with a set number of lanes per macro. As an example, a link macro can have 14 lanes. The lanes are not designated as data or redundant lanes inside the link macro. Instead, a logic layer associated with the link macro can configure the link macros to be able to repair a certain number of data lanes with a certain number of redundant lanes. The link macros, including portions of link macro, can be grouped into repair groups. The size of each repair group is configurable. The number of data lanes that can be repaired per repair group is configurable and can be determined or programmed on a per usage case. In one example, the number of data lanes that can be repaired is determined on a group by group basis, such that one can configure the number of data lanes that can be repaired within a group. The group size can be selected independently of the number of repair lanes. This allows a trade-off between redundant lanes and repair lanes for different groups. For example, one can choose to repair two lanes out of 20 data lanes or repair three lanes out of 24 data lanes. Moreover, not only is the size of the repair group and the number of redundant lanes per repair group configurable, but the location of the redundant lanes within a die floor plan is also configurable. As an example, one can choose to select the redundant lanes as the two lanes in the right hand corner of a link macro, the left hand corner of the link macro, or anywhere else within the repair group. The die-to-die lane repair can be configurable depending on the assembly and packaging yield properties, which may change over time. Different configurations may also be chosen based on the pitch of the micro-bumps or other such interconnecting structures that are included in the link macros for interconnection with structures, such as interposers.

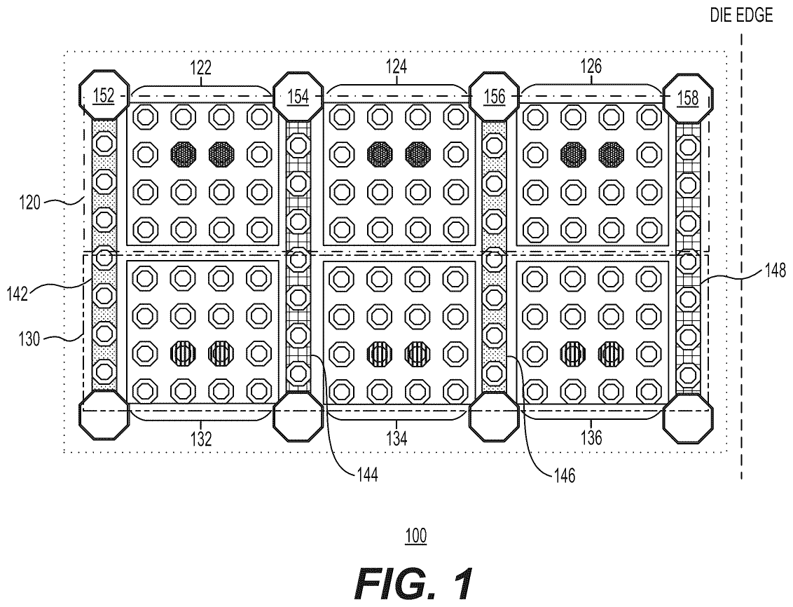

FIG. 1 shows an example die-to-die (D2D) node 100 for use as part of a multi-die system with modular D2D link macros for enabling configurable die-to-die lane repair. Each D2D node can be viewed as a physical aggregation of components, where each of the components further includes sub-components. The vertical dotted line shown in FIG. 1 identifies the die edge for D2D node 100. In this example, each D2D node 100 includes one or more clusters of D2D link macros. Each D2D link macro may only be a transmit link macro or a receive link macro. While one could combine transmit link macros and receive link macros in the form of clusters or another such arrangement, each D2D link macro is limited to being only one of a kind-a transmit link macro or a receive link macro. In this example, D2D node 100 is shown as including two clusters of D2D link macros. Cluster 120 includes three transmit link macros 122, 124, and 126. Cluster 130 includes three receive link macros 132, 134, and 136. In this example, each cluster shares a clock spine, which is used to distribute clock signals to all of the D2D link macros included in a respective cluster.

With continued reference to FIG. 1, D2D node 100 includes power and ground distribution via columns of power and columns of ground. In this example, D2D node 100 includes two columns of power-power column 142 and power column 146. Moreover, in this example, D2D node includes two columns of ground-ground column 144 and ground column 148. The combination of these columns, which are arranged between the link macros, allows for efficient distribution of power within the D2D node 100. In addition, D2D node 100 includes several sacrificial (SAC) pads. Probing can be performed using these SAC pads instead of using the micro-bumps associated with the link macros. As an example, D2D node 100 is shown with several SAC pads along the periphery of the D2D node 100, including SAC pads 152, 154, 156, and 158. The SAC pads are formed along with the micro-bumps and probing is performed using the SAC pads instead of the micro-bumps. The tests may relate to package/die testing, including tests to determine whether the package/die is a good package/die in terms of no presence of any opens or shorts along the various nets being tested. As an example, automated test equipment (ATE) may be connected to an IC prober, which may have probes in direct contact with bumps for testing. The probes may provide voltage for testing to the bumps to test for any defects in the package. Although FIG. 1 shows D2D node 100 as having a certain number of clusters and D2D link macros that are arranged in a certain manner, D2D node 100 may include additional or fewer clusters and/or D2D link macros that are arranged differently.

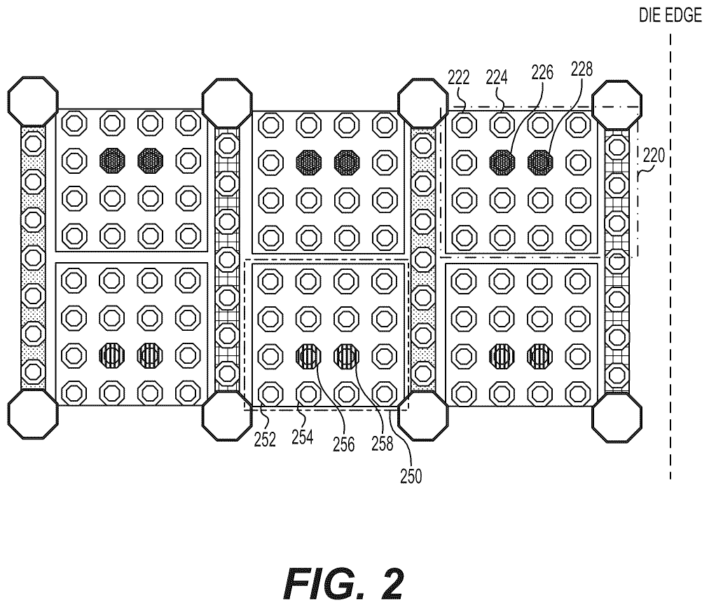

FIG. 2 shows additional details of a D2D transmit link macro 220 and a D2D receive link macro 250 for use with the D2D node 100 of FIG. 1. To explain further modular characteristics of the D2D link macros, the details of two different types of D2D link macros (e.g., transmit v. receive) are provided. In this example, each D2D link macro has the same physical size and shape (e.g., each of the macros shown in FIG. 1 is a square-shaped macro). The use of the modular D2D link macros allows one to offer various combinations of bandwidths and chip edge depths. Advantageously, because of the modularity associated with the D2D link macros, including the same shape, the same size, and bandwidth capacity, the modular D2D link macros can be deployed to achieve a good outcome for any given use case without substantial re-design of the D2D nodes.

Each D2D link macro supports the same number of lanes, which can be used to transmit (or receive) data signals or to transmit (or receive) clock signals. D2D transmit link macro 220 includes fourteen data-related bumps and two clock-related bumps. In this example, bumps 222 and 224 correspond to the data-related bumps and bumps 226 and 228 correspond to the clock-related bumps. Similarly, D2D receive link macro 250 includes further data-related bumps and two clock-related bumps. In this example, bumps 252 and 254 correspond to the data-related bumps and bumps 256 and 258 correspond to the clock-related bumps. The bumps themselves may be implemented as micro-bumps or other types of interconnection structures for use with dies. Although FIG. 2 shows D2D transmit link macro 220 and D2D receive link macro 250 as having a certain number of bumps that are arranged in a certain manner, each of these macros may include additional or fewer bumps that are arranged differently.

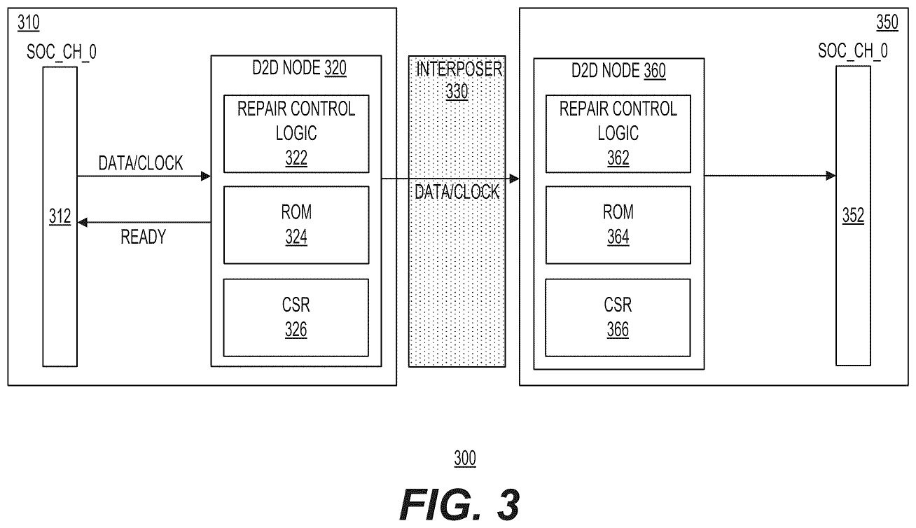

FIG. 3 shows a block diagram of an example multi-die system 300 having modular D2D link macros for enabling configurable die-to-die lane repair. The block diagram for multi-die system 300 shown in FIG. 3 illustrates the logical aspects of the use of the D2D link macros in the context of multi-die systems, such as the multi-die system 300. Multi-die system 300 includes a die 310 coupled with another die 350 using an interposer 330. Die 310 includes D2D node 320 and die 350 includes D2D node 360. The purpose of each of the D2D nodes (having D2D link macros) is to transport the contents of a bus included within one die to another bus included in another die. Die 310 includes a system-on-chip (SoC) channel 312 (SOC_CH_0), which is coupled to D2D node 320, located within die 310. SoC channel 312 can provide data, clock, and valid signals to D2D node 320. D2D node 320 can transmit the data along with a clock signal to D2D node 360 located within die 350 via interposer 330. The SoC channel 352 can receive control signals (e.g., READY) from D2D node 360. Die 350 includes an SoC channel 352 (also labeled as SOC_CH_0), which can be used to receive data and clock signals from D2D node 360, which is also located within die 350. For ease of explanation, in this example, the busses on the two dies are shown as identical in terms of their bandwidth (e.g., 390 bits).

With continued reference to FIG. 3, the principal function of the D2D nodes and the D2D links is to transport data from one die to the other die. Any number of SoC channels from die 310 can be transported across the die edge to the interposer 330 and then from the interposer to die 350. As explained earlier, in physical terms, each D2D node can include clusters of D2D link macros that can be transmit link macros or receive link macros. Aside from the link macros, each of the D2D node 320 and D2D node 360 includes additional functionality to enable configurable die-to-die lane repair. In this example, D2D node 320 includes repair control logic 322, read-only memory (ROM) 324, and control and status register (CSR) 326. Similarly, D2D node 360 includes repair control logic 362, ROM 364, and CSR 366. The repair control logic in each D2D node (e.g., repair control logic 322 and 362) is used to enable configurable die-to-die lane repair. The ROM (e.g., each of ROM 324 and ROM 364) comprises e-fuses or other types of hard-coded information relating to die-to-die lane repair, including which redundant lanes are being used and for which data lanes. The CSR (e.g., each of CSR 326 and CSR 366) are on-die registers that can be used to store information read from the ROM. Additional details regarding the use of these components are provided with respect to the examples of configurable die-to-die lane repair examples described later. Although FIG. 3 shows multi-die system 300 including a certain number of D2D nodes for enabling configurable die-to-die lane repair, multi-die system 300 may include more or fewer such components, which could be arranged differently from the arrangement shown in FIG. 3. As an example, each of the D2D nodes need not include the ROM; instead, only one of the dies that is part of the multi-die system 300 may include the pertinent lane repair-related information. As another example, although FIG. 3 shows multi-die system 300 with unidirectional communication from the first die 310 to the second die 350, multi-die system 300 can be bidirectional, as well.

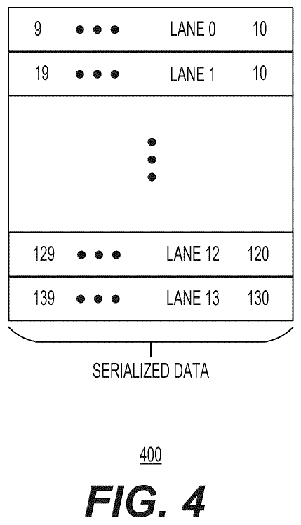

FIG. 4 is an example modular D2D transmit link macro 400 for use with multi-die systems with configurable die-to-die lane repair. As explained earlier, the physical D2D links between the two dies are implemented using a certain number of lanes per D2D link macro and serialization of the data across the D2D links. In this example, the modular D2D transmit link macro 400 is capable of handling 10 bits per lane, which are then sent as serialized data across the physical D2D link, resulting in a serialization of 10:1. Example D2D transmit link macro 400 is shown with fourteen lanes (LANE 0, LANE 1, . . . . LANE 12, and LANE 13). Although FIG. 4 shows the D2D transmit link macro 400 as having a certain number of lanes with a certain number of bits per lane, the D2D transmit link macro 400 could have additional or fewer lanes with a different number of bits per lane.

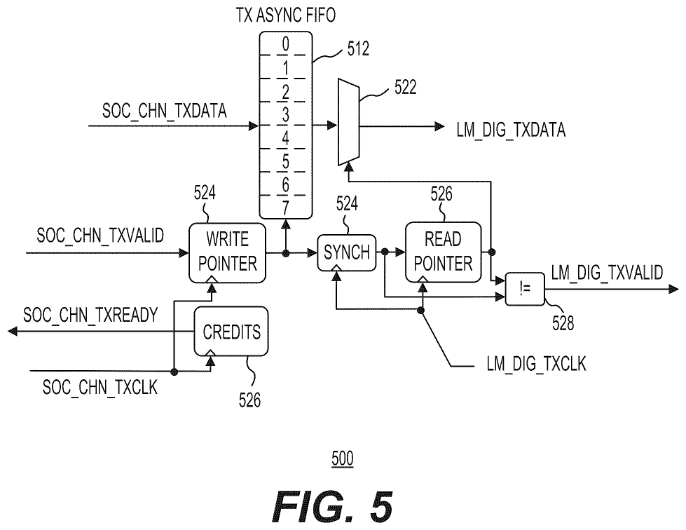

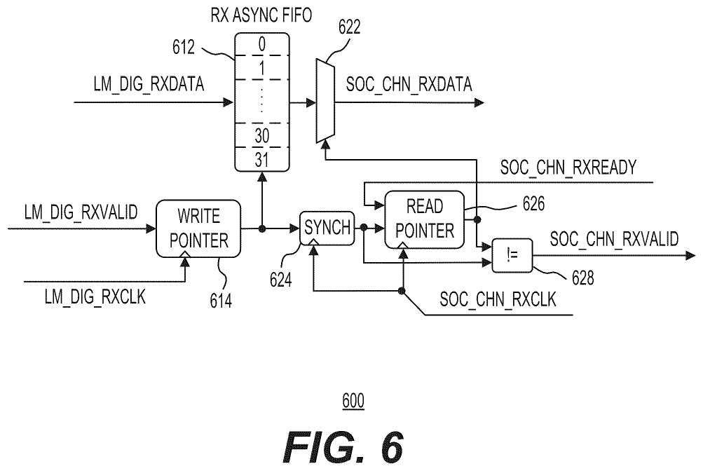

FIG. 5 shows a block diagram of an example modular D2D transmit link macro 500 for use with multi-die systems with configurable die-to-die repair. FIG. 6 shows a block diagram of an example D2D receive link macro 600 for use with multi-die systems with configurable die-to-die repair. As an example, D2D transmit link macro 500 could be implemented as the D2D link macro 300 of FIG. 3, which offers a capacity of 10-bits per lane and has 14 data lanes. In this example, D2D transmit link macro 500 is configured to process a system-on-chip (SoC) channel (e.g., a system bus associated with the SoC) with a bandwidth of a certain number of bits (e.g., 140 bits) and provide those for serialization. The serialized data is then transmitted via an interposer (or another packaging structure) to the receive link macros (shown in FIG. 6). The data output by the D2D transmit link macro 500 is serialized prior to the transmission using a serializer block (not shown). Table 1 below provides a brief explanation for the various signals (shown in FIG. 5) associated with the D2D transmit link macro 500.

TABLE 1

| D2D Transmit Link | |
|---|---|
| Marco Signals | Brief Explanation |
| SOC_CHN_TXDATA | Data for transmission from the pertinent SoC |
| | channel to the D2D transmit link macro. |
| SOC_CHN_TXVALID | Control signal for the write pointer from the |
| | pertinent SoC channel indicating valid |
| | transmit data. |
| SOC_CHN_TXCLK | Transmit clock associated with the pertinent |
| | SoC channel. |
| SOC_CHN_TXREADY | Ready signal from the D2D transmit link |
| | macro to the SoC channel. |
| LM_DIG_TXDATA | Data for transmission from the D2D transmit |
| | link macro, which is serialized, and then |
| | transmitted to another die. |
| LM_DIG_TXCLK | Transmit clock associated with the D2D |
| | transmit link macro. |
| LM_DIG_TXVALID | Control signal indicative of whether the |
| | transmit data is valid. |

With continued reference to FIG. 5, in this example, the D2D transmit link macro 500 includes a transmit asynchronous FIFO (TX ASYNC FIFO 512), which is used to receive the data to be transmitted (e.g., SOC_CHN_TXDATA of table 1). The D2D transmit link macro 500 further includes a write pointer 514, a block for managing flow using credits (e.g., CREDITS 516), a synchronization channel block (e.g., SYNCH 524), and a read pointer 526. The write pointer 514 points to the data in the TX ASYNC FIFO 512 and it advances through the FIFO once the write pointer 514 receives a valid signal (e.g., SOC_CHN_TXVALID of table 1). The write pointer 514 is synchronized with the read pointer 526 using the synchronization channel block (e.g., SYNCH 524). As shown in FIG. 5, both the synchronization channel block (e.g., SYNCH 524) and the read pointer 526 are synchronized using a transmit link macro clock signal (e.g., LM_DIG_TXCLK of table 1). This allows the read pointer 526 to follow the write pointer 514 with a certain delay in between. The read pointer 526 outputs a signal that is used to control the output of multiplexer 522, which receives the data to be transmitted from the TX ASYNC FIFO 512. A logic block 528 that implements the !=equality is provided the output of both the read pointer 526 and the synchronization channel block (e.g., SYNCH 524). Logic block 528 processes the two input signals and generates a control signal (e.g., LM_DIG_TXVALID of table 1) indicating whether the data to be transmitted is valid. Although FIG. 5 shows D2D transmit link macro 500 as including certain components arranged in a certain manner, D2D transmit link macro 500 could include additional or fewer components that are arranged differently.

FIG. 6 shows a block diagram of a modular D2D receive link macro 600 for use with power efficient bidirectional die-to-die communication systems and methods. On the receive side, the serialized data, received via an interposer (or a similar structure), is de-serialized using a de-serializer block (not shown). The de-serialized data is then processed by the D2D receive link macro 600. As an example, if the transmit side sent 140 bits after serialization then the D2D receive link macro 600 processes those bits. Table 2 below provides a brief explanation for the various signals (shown in FIG. 6) associated with the D2D receive link macro 600.

TABLE 2

| D2D Receive Link | |
|---|---|
| Marco Signals | Brief Explanation |
| LM_DIG_RXDATA | Data, which has been de-serialized, |
| | received from another die by the D2D |
| | receive link macro. |
| LM_DIG_RXCLK | Receive clock associated with the D2D |
| | receive link macro. |
| LM_DIG_RXVALID | Control signal indicative of whether |
| | the receive data is valid. |
| SOC_CHN_RXDATA | Data provided by the D2D receive link |
| | to the pertinent SoC channel. |
| SOC_CHN_RXVALID | Control signal for the SoC channel |
| | indicating valid receive data. |
| SOC_CHN_RXCLK | Receive clock associated with the pertinent |
| | SoC channel. |
| SOC_CHN_RXREADY | Ready signal from the pertinent SoC channel |
| | to D2D receive link macro. |

With continued reference to FIG. 6, in this example, the D2D receive link macro 600 includes a receive asynchronous FIFO (RX ASYNC FIFO 612), which is used to receive the de-serialized data (e.g., LM_DIG_TXDATA of table 2). The D2D receive link macro 600 further includes a write pointer 614, a synchronization channel block (e.g., SYNCH 624), and a read pointer 626. The write pointer 614 points to the data in the RX ASYNC FIFO 612 and it is synchronized with the read pointer 626 using the synchronization channel block (e.g., SYNCH 624). As shown in FIG. 6, both the synchronization channel block and the read pointer 626 are synchronized using a SoC channel receive clock signal (e.g., SOC_CHN_RXCLK of table 2). The read pointer 626 outputs a signal that is used to control the output of multiplexer 622, which receives the data from the RX ASYNC FIFO 612 and outputs the received data to the respective SoC channel (e.g., as SOC_CHN_RXDATA of table 2). In terms of reading the data, the read side of the RX ASYNC FIFO 612 waits for all of the pointers to advance to the same value before reading out the location of the RX ASYNC FIFO 612. A logic block 628 that implements the !=equality is provided the output of both the read pointer 626 and the synchronization channel block (e.g., SYNCH 624). Logic block 628 processes the two input signals and generates a control signal (e.g., SOC_CHN_RXVALID of table 2) indicating whether the data for the respective SoC channel is valid. Although FIG. 6 shows D2D receive link macro 600 as including certain components arranged in a certain manner, D2D receive link macro 600 could include additional or fewer components that are arranged differently.

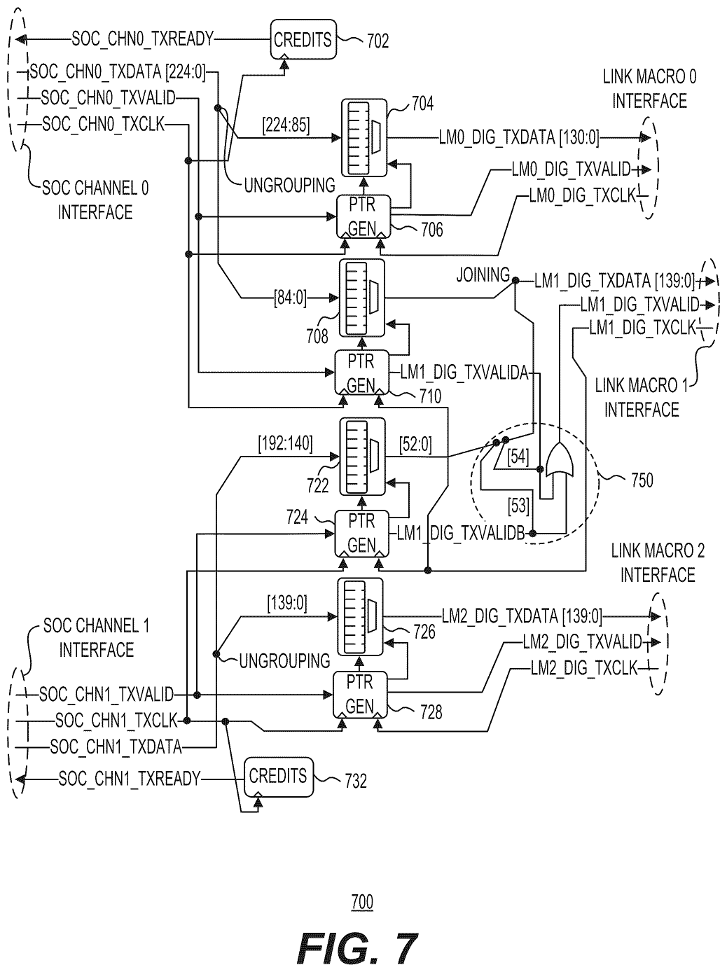

FIG. 7 shows an example set of D2D transmit link macros 700 for use with multi-die systems. As explained earlier, the transmit link macros can be modular, allowing for a wide configurations of bandwidth and chip edge depth combinations. The set of D2D transmit link macros 700 can be used to receive data from one or more SoC channels and transfer the data via D2D links. As described earlier, the D2D transmit link macros can process the data received from the SoC channels, and after serialization, the data can be transmitted via D2D links to another die via an interposer or similar structure. In this example, the set of D2D transmit link macros 700 assumes a lack of perfect alignment in terms of the bandwidth of the pertinent SoC channel and the bandwidth offered by the D2D transmit link macro. As an example, D2D transmit link macros 700 can be implemented with similar components as described earlier with respect to D2D transmit link macro 500 of FIG. 5 with additional logic for ungrouping and joining. In terms of ungrouping, as an example a specific SoC channel having a bandwidth that exceeds the bandwidth of a single D2D transmit link macro can be ungrouped for transport across joined D2D transmit link macros. At the receive side, the ungrouped SoC channel can be grouped using split D2D receive link macros. In this example, to enable grouping and ungrouping, all of the FIFOs at both the transmit side and the receive side are initialized at the same time when the D2D nodes are initialized upon the SoC powering up.

With continued reference to FIG. 7, in this example, the set of D2D transmit link macros 700 is configured to transmit data from two SoC channels: SOC_CH_0 and SOC_CH_1. This example assumes that SOC_CH_0 1 has a bandwidth of 225 bits in terms of the data that requires transmission and that SOC_CH_1 1 has a bandwidth of 193 bits in terms of the data that requires transmission. In this example, the set of D2D transmit link macros 700 includes three D2D transmit link macros. In this example, each of the set of D2D transmit link macros 700 supports 14 data lanes, where each lane is capable of handling 10 bits (e.g., similar to modular D2D transmit link macro 500 of FIG. 5), resulting in the bandwidth capacity of 140 bits. Notably, in this example, each of the SoC channels has a bandwidth that exceeds the bandwidth capacity of an individual D2D transmit link macro. To allow for transmission of data, the data from the first SoC channel (e.g., SOC_CH_0) is ungrouped into a first group of data and a second group of data. Similarly, the data from the second SoC channel (SOC_CH_1) is ungrouped into a third group of data and a fourth group of data. In this example, a first D2D transmit link macro is configured to transmit the first group of data, a second D2D transmit link macro is configured to transmit both the second group of data and the third group of data, and a third D2D transmit link macro is configured to transmit the fourth group of data.

Still referring to FIG. 7 the data output by each of the set of D2D transmit link macros 700 is serialized prior to the transmission using a serializer block (not shown). Similar signals as described earlier with respect to table 1 in the context of FIG. 5 are associated with the set of D2D transmit link macros 700. In this example, each set of D2D transmit link macro 700 includes some of the same circuitry as described earlier with respect to D2D transmit link macro 500. As an example, the set of D2D transmit link macros 700 include circuitry for flow control, such as credits 702 and credits 732. The set of D2D transmit link macros 700 further includes circuitry associated with FIFOs (e.g., FIFO blocks 704, 708, 722, and 726) and pointer generation (e.g., pointer generation blocks 706, 710, 724, and 728). Each of the FIFOs included in FIFO blocks 704, 708, 722, and 728 waits for all the associated pointers to advance to the same value before reading out the location of the FIFO. The set of transmit link macros 700 further includes control logic 750 for generating signals that permit joining of data for transmission by a shared D2D transmit link macro. A valid signal is inserted into the data path for each SoC bus that is ungrouped. As shown in FIG. 7, bits 53 and 54 carry the valid signal for the two SoC channels that were ungrouped. Using control logic 750, these bits are processed to validate the data and generate the LM1_DIG_TXVALID signal for transmission to the receive side. Although FIG. 7 shows the set of D2D transmit link macros 700 as having a certain number of components that are arranged in a certain manner, the D2D transmit link macros 700 may include additional or fewer components that are arranged differently.

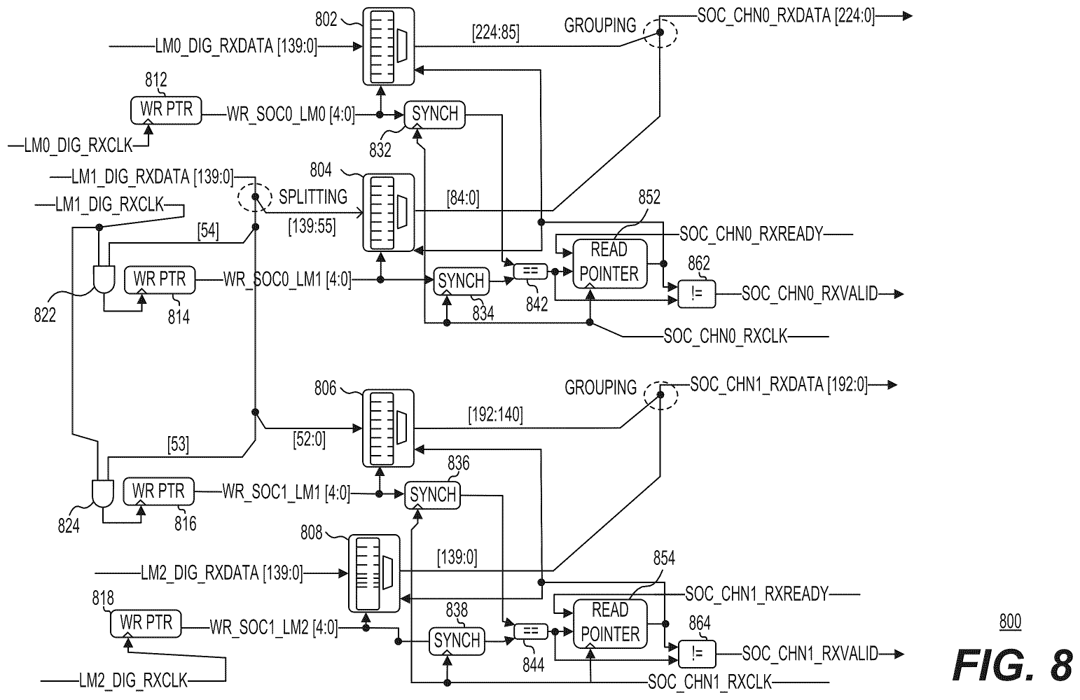

FIG. 8 shows an example set of D2D receive link macros 800 for use with the set of D2D transmit link macros 700 of FIG. 7. As explained earlier, the receive link macros can be modular, allowing for a wide configurations of bandwidth and chip edge depth combinations. The set of D2D receive link macros 800 can be used to receive data via the D2D links. As described earlier, the D2D receive link macros can process the data received from D2D links, and after de-serialization, the data can be transferred to the SoC channels within the SoC (or a similar system). As an example, each of the set of D2D receive link macros 800 can be implemented with similar components as described earlier with respect to D2D receive link macro 600 of FIG. 6 with the additional logic for splitting and grouping. In this example, the set of D2D receive link macros 800 includes three D2D receive link macros. In this example, each of the set of D2D receive link macros 800 supports 14 data lanes, where each lane is capable of handling 10 bits, resulting in a bandwidth capacity of 140 bits. The first group of data corresponding to SoC channel 0 is received via one of the set of D2D receive link macros 800. The second group of data (corresponding to SoC channel 0), which was ungrouped at the transmit side, is received by one of the second set of D2D receive link macros 800. The third group of data (corresponding to SoC channel 1) is received via the one of the second set of D2D receive link macros 800, and the fourth group of data (corresponding to SoC channel 1) is received by one of the third set of D2D receive link macros 800.

With continued reference to FIG. 8, similar signals as described earlier with respect to table 2 in the context of FIG. 6 are associated with the set of D2D receive link macros 800. In this example, each set of D2D receive link macro 800 includes some of the same circuitry as described earlier with respect to D2D receive link macro 600 of FIG. 6. As an example, the set of D2D receive link macros 800 includes circuitry associated with FIFOs (e.g., FIFO blocks 802, 804, 806, and 808) and write pointer generation circuitry (e.g., WR PTR blocks 812, 814, 816, and 818). The set of D2D receive link macros 800 further includes control logic (e.g., AND gates 822 and 824) for generating signals that are used for splitting of the data for processing by a shared D2D receive link macro. The set of D2D receive link macros 800 further includes synchronization channel blocks (e.g., SYNCH 832, SYNCH 834, SYNCH 836, and SYNCH 838), and read pointers (e.g., READ POINTER 852 and READ POINTER 854). As explained earlier with respect to FIG. 6, each respective write pointer points to the data in the respective receive FIFO and it is synchronized with the respective read pointer using the respective synchronization channel block. In terms of reading the data, as described earlier with respect to FIG. 6, the read side waits for all of the pointers to advance to the same value before reading out the location of the receive FIFO. To allow for the grouping of the data received from different SoC channels, logic blocks 842 and 844 that implement the equality operation are used at the input of the respective read pointer. Additional logic blocks 862 and 864 that implement the !=equality are provided the output of both the respective read pointer and the respective logic blocks 842 and 844. Although FIG. 8 shows the set of D2D receive link macros 800 as having a certain number of components that are arranged in a certain manner, the set of D2D receive link macros 800 may include additional or fewer components that are arranged differently.

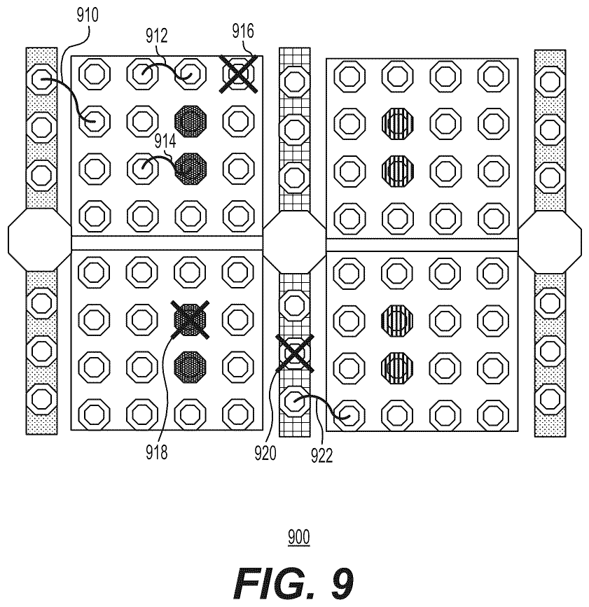

FIG. 9 shows an example D2D node 900 illustrating some of the fault scenarios that can occur in multi-die systems. For ease of explanation, this example assumes that the multi-die system includes dies that have micro-bumps for connecting data, clock, and power/ground to the interposer or a similar structure. Instead of micro-bumps, other connection structures such as hybrid bonds or other types of bumps may also be used. The various fault scenarios can include: (1) a neighbor short; (2) a short to ground (e.g., VSS); (3) a short to power supply (e.g., VDD); or (4) an open failure. As an example, fault 910 shows a short between a data micro-bump and a power micro-bump. Fault 912 corresponds to a short between a data micro-bump and another data micro-bump. Fault 914 corresponds to a short between a data micro-bump and a clock micro-bump. Fault 916 corresponds to an open failure with respect to a data micro-bump. Fault 918 corresponds to an open failure with respect to a clock micro-bump. Fault 920 corresponds to an open failure with respect to a ground micro-bump. Fault 922 corresponds to a short between a data micro-bump and a ground micro-bump. Short and open failures can occur along a route connecting the micro-bumps, as well. As an example, both short and open failures can occur in wires or other types of interconnection structures formed as part of an interposer or other such arrangements. Not all faults can be repaired using the redundant lanes. In the case shown in FIG. 9, faults 912, 914, and 922 can be repaired using one redundant lane. In this example, fault 918 does not need any repair since there are two clock bumps, and as long as one of them is not faulty, clock signals can be communicated. In addition, fault 920, which relates to an open ground, also does not need repair, since there are other bumps along the ground column that are fine. Fault 912, which relates to a short between two data lanes, can be repaired using two redundant lanes. In this example, fault 914, which is a short between a data micro-bump and a clock micro-bump, cannot be repaired. Other faults that are not shown may occur, as well. As an example, during package sorting, tests could be run to determine which of the data lanes are more susceptible to soft errors, such as bit flips or other types of such errors.

As described earlier, the link macros (transmit and receive) have a set number of lanes per macro. As an example, a link macro can have 14 lanes (e.g., FIG. 4 shows a link macro with 14 lanes). The lanes are not designated as data or redundant lanes inside the link macro. Instead, a logic layer associated with the link macro can configure the link macros to be able to repair a certain number of data lanes with a certain number of redundant lanes. The number of data lanes that can be repaired per link macro is configurable and can be determined or programmed on a per usage case. In one example, the number of data lanes that can be repaired is determined on a group by group basis, such that one can configure the number of data lanes that can be repaired within a group. The group size can be selected independently of the number of repair lanes. This allows a trade-off between redundant lanes and repair lanes for different groups. For example, one can choose to repair two lanes out of 20 data lanes or repair three lanes out of 24 data lanes. The die-to-die lane repair can be configurable depending on the assembly and packaging yield properties, which may change over time. Different configurations may also be chosen based on the pitch of the micro-bumps or other such interconnecting structures that are included in the link macros for interconnection with structures, such as interposers.

Advantageously, with the configurable die-to-die lane repair, the lane repair can be structured based on the maturity of the packaging technology. As the technology matures, the required amount of redundancy goes down. In addition, different die-to-die lane repair configurations can be achieved without requiring major design changes. As an example, register transfer language (RTL) updates can be used to change the die-to-die lane repair configuration. Because of the inherent quantization in the use of D2D link macros, the configurability of the lane repair allows a more efficient use of the D2D links for interconnecting dies as part of a multi-die system. If any issues arise during the assembly process that need to be protected against, the configurable nature of the die-to-die lane repair allows the D2D links to be re-configured to improve assembly yield for a particular assembly issue.

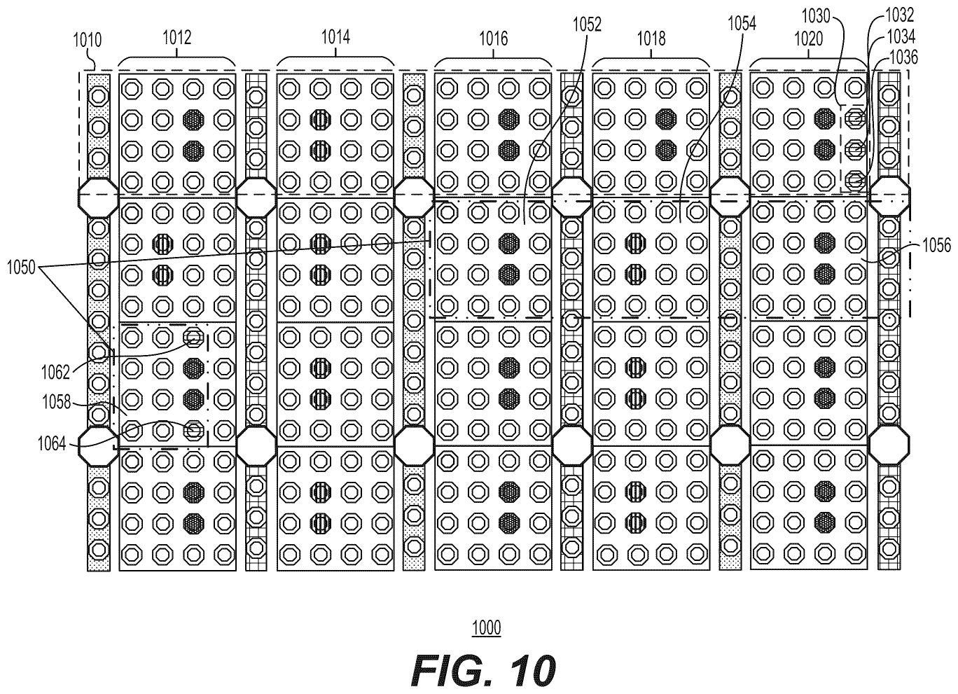

FIG. 10 shows a set of modular link macros 1000 that can have different configurations of die-to-die lane repair. Broadly speaking, the repair group size is fully configurable, in that it can be any number of lanes. A group can include one or more full link macros and a certain number of lanes from another link macro. Moreover, the number of lanes in a group and the number of lanes that can be repaired is fully configurable. As an example, to illustrate the configurability of the die-to-die lane repair, the set of link macros 1000 is shown with two example repair groups: (1) repair group 1010 including link macros 1012, 1014, 1016, 1018, and 1020, and (2) repair group 1050 including link macros 1052, 1054, 1056, and a portion of a link macro 1058. While repair group 1010 includes four modular link macros, repair group 1050 includes three modular link macros and only a subset of the lanes from another modular link macro. The configurable die-to-die lane repair allows one to keep the advantages associated with the modular link macros, while at the same time providing additional advantages associated with different repair group sizes, different number of repair lanes per repair group (as needed), and different locations of the micro-bumps (or other endpoints) for the redundant lanes within the die floor plan of the repair group. In addition, the configurability allows one to increase the number of redundant lanes if package sorting (through package testing) indicates lower yield related to faults associated with the lanes. Such testing can also help identify the locations for the redundant lanes. As an example, redundant lanes may be placed in regions of the repair groups that have lower soft errors or other desirable characteristics.

Repair group 1010 has three redundant lanes 1032, 1034, and 1036 located in a region 1030, which is at the right hand bottom corner of the die floor plan for repair group 1010. In contrast, repair group 1050 has only two redundant lanes 1062 and 1064, which are located adjacent to the clock micro-bumps. In case of repair group 1010 there are a total of 53 ((4×14)−3) payload lanes (payload lanes include both data and clock lanes) and 3 redundant lanes. In one example, the three redundant lanes can be used to repair any of the 53 payload lanes. In case of repair group 1050 there are a total of 36 ((2×14+10)−2) payload lanes and 2 redundant lanes. In one example, the two redundant lanes can be used to repair any of the 36 payload lanes. Although FIG. 10 shows a certain number of repair groups having a certain number of repair lanes, the set of link macros 1000 can have additional or fewer repair groups with different numbers of repair lanes. In addition, although FIG. 10 shows examples of repair groups with a configuration in which any of the payload lanes can be repaired using the corresponding redundant lanes, other configurations that allocate repairability to a smaller set of the payload lanes could also be deployed.

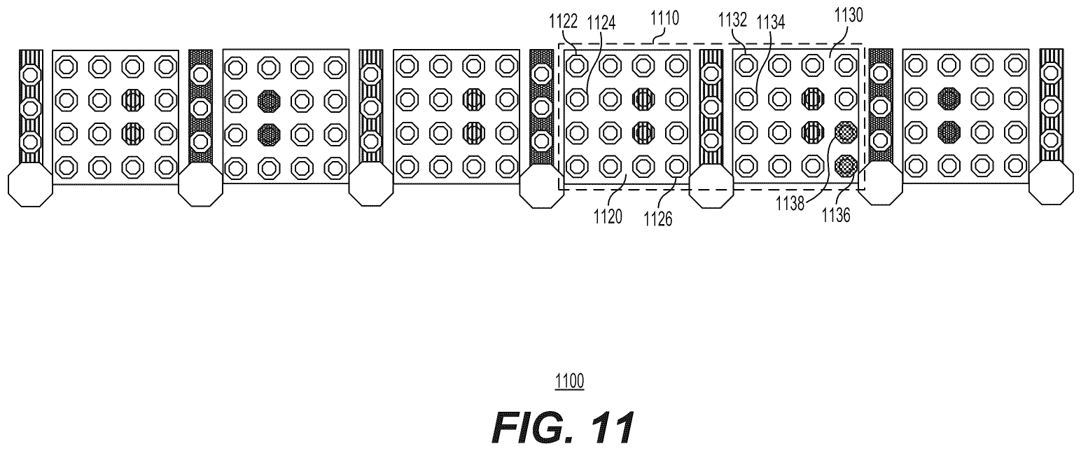

FIG. 11 shows a set of modular link macros 1100 with a repair group 1110 to explain the configurability of the die-to-die lane repair. Repair group 1110 includes transmit link macros 1120 and 1130. Transmit link macro (LM0) 1120 includes micro-bump 1122 (corresponding to a lane labeled as LM0_LN0), micro-bump 1124 (corresponding to a lane labeled as LM0_LN1), and micro-bump 1126 (corresponding to a lane labeled as LM0_LN13). Thus, in this example, the 14 lanes included in transmit link macro 1120 start with LM0_LN0 at the top left side of transmit link macro 1120, and are then counted column-by-column moving to the right. Transmit link macro (LM1) 1130 includes micro-bump 1132 (corresponding to a lane labeled as LM1_LN0), micro-bump 1134 (corresponding to a lane labeled as LM1_LN1), micro-bump 1136 (corresponding to a lane labeled as LM1_LN12), and micro-bump 1138 (corresponding to a lane labeled as LM1_LN13). Lanes LM1_LN12 and LM1_LN13 are the two redundant lanes included in repair group 1110. Thus, in the case of repair group 1110 there are a total of 26 ((2×14)−2) payload lanes (payload lanes include both data and clock lanes) and 2 redundant lanes. In this example, the two redundant lanes can be used to repair any of the 26 payload lanes. Although FIG. 11 shows micro-bumps 1136 and 1138 in the right hand bottom corner of FIG. 11, they need not be limited in this regard. Indeed, the redundant lanes can be placed in any part of the floor plan corresponding to the repair group. As an example, repair group 1110 includes two link macros with a certain floor plan, the redundant lanes could correspond to any of the other data lanes, excluding the micro-bumps for clock signals. Moreover, repair group 1110 could be larger or smaller and could include more or fewer redundant lanes.

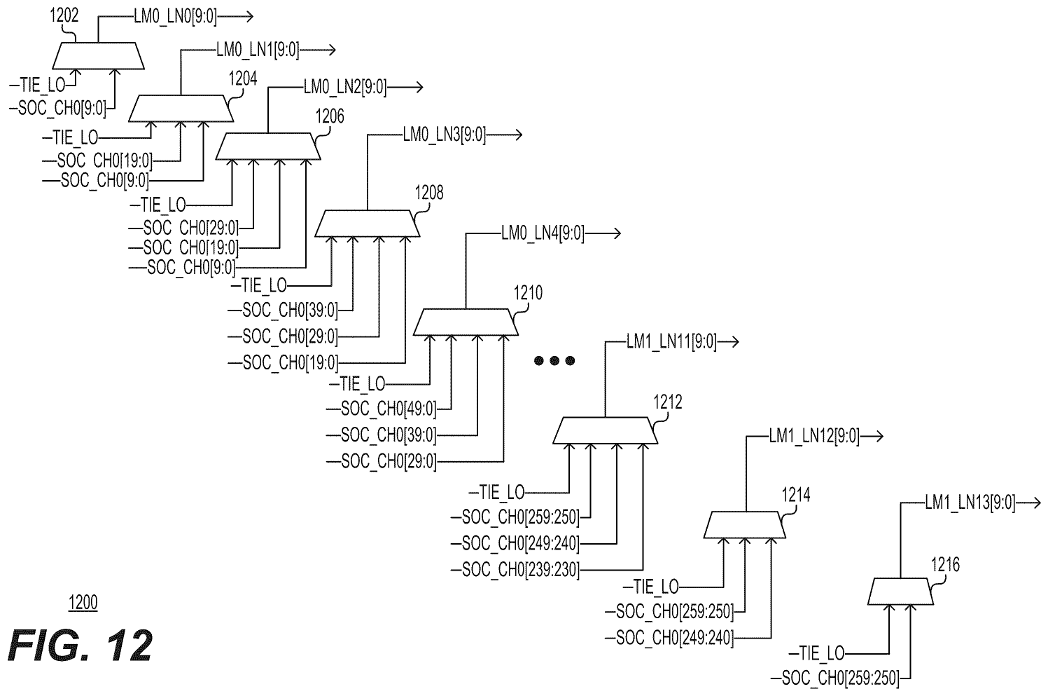

FIG. 12 shows a logical view of a transmit data path 1200 for the repair group 1110 of FIG. 11. Transmit data path 1200 can carry a data payload of 260 bits via SoC channel SOC_CH0. Since each of the payload lanes includes 10 bits, 26 lanes are needed to transmit 260 bits corresponding to the SoC channel SOC_CH0. As explained with respect to FIG. 11, repair group 1110 includes two redundant lanes: LM1_LN12 and LM1_LN13. This would mean that any two lanes from among the 26 lanes can fail and the lane-repair logic will shift data appropriately. From a logical point of view, transmit data path 1200 includes several multiplexers that can be used to shift the logical lanes to allow for the lane repair. As an example, if a path associated with transmit data path 1200 includes a two-input multiplexer, then the data lane can be shifted by one. If on the other hand, a path associated with transmit data path 1200 includes a three-input multiplexer, then the data lane can be shifted by two. In sum, a different amount of redundancy can be achieved by using appropriate shift logic and repair control logic to control the shifting. Transmit data path 1200 is shown with several multiplexers, including multiplexers 1202, 1204, 1206, 1208, and 1210 that correspond to the data lanes associated with a link macro identified as LM0. In addition transmit data path shown with multiplexers 1212, 1214, and 1216 that correspond to the data lanes associated with another link macro identified as LM1. Each of the multiplexers has an input identified as TIE_LO, which is an input that can be used to transmit a fixed pattern (e.g., zeros) through a lane that has been identified as needing repair, and has been repaired by using a redundant lane. In addition, each of the multiplexers is shown as having one to four inputs corresponding to the SoC channel data, where each input has 10 bits, which can be carried as data by a respective data lane associated with the link macro (e.g., data lane LM0_LN0[9:0] can carry either the data corresponding to the TIE_LO input or the data corresponding to the SOC_CH0[9:0] input).

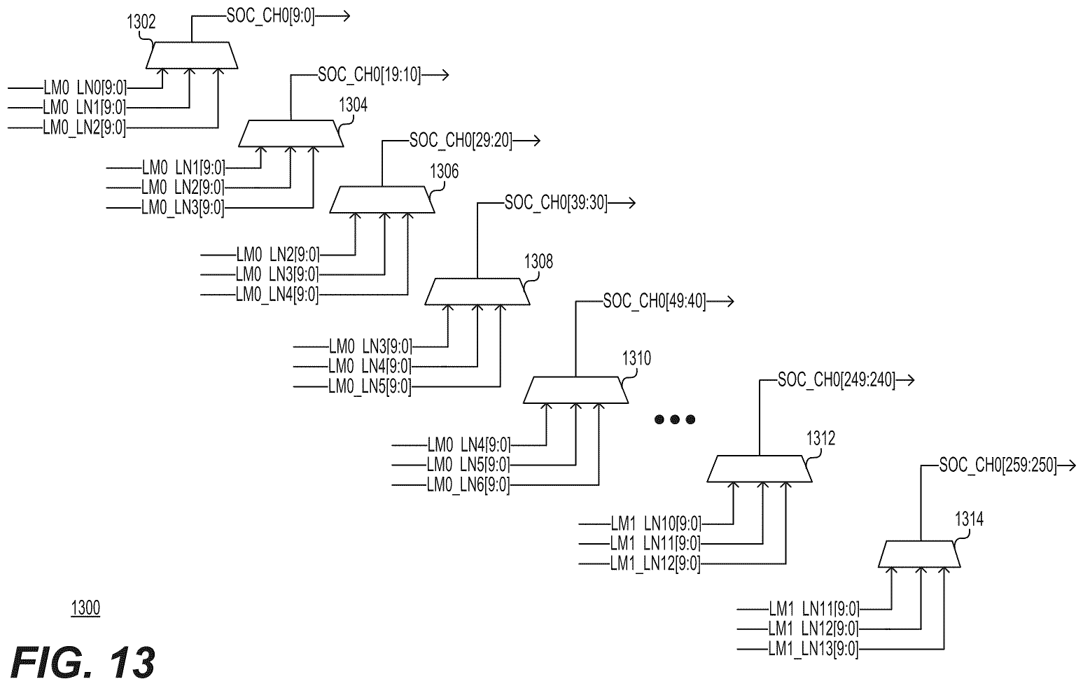

FIG. 13 shows a logical view of a receive data path 1300 for the repair group 1110 of FIG. 11. Receive data path 1300 corresponds to the transmit data path 1200 of FIG. 12. Thus, the link macro data lanes shown in FIG. 12 carry the data, which is received by the SoC channel (SOC_CH0) shown in FIG. 13. From a logical point of view, receive data path 1300 includes several multiplexers (e.g., multiplexers 1302, 1304, 1306, 1308, and 1310 for receiving data from link macro LM0 and multiplexers 1312 and 1314 for receiving data from link macro LM1) that can be used to receive data inputs. Each of the multiplexers associated with the receive data path 1300 includes three inputs (one for each link macro data lane) and one output (one for each of the 10 bits associated with the SoC channel).

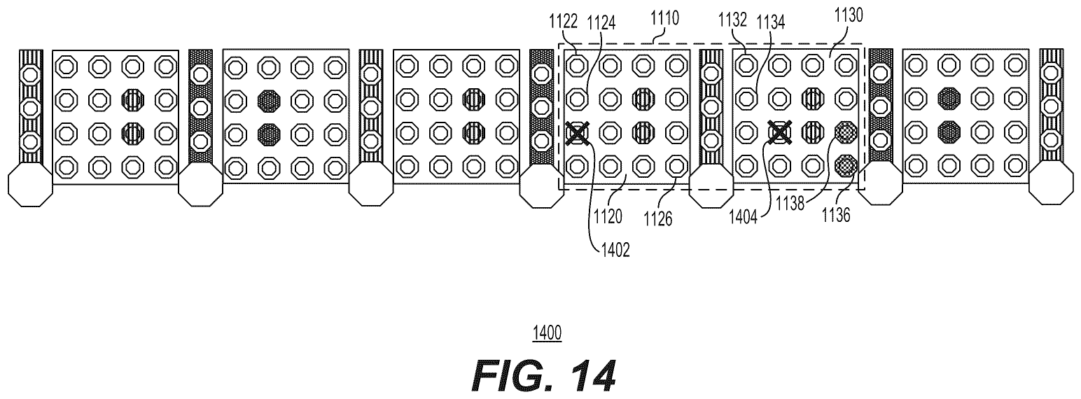

FIG. 14 shows a diagram 1400 of the set of link macros 1100 of FIG. 11, including faults within the repair group 1110 to further explain the configurability of the die-to-die lane repair. Unless indicated otherwise, the same or similar components that are shown in FIG. 14 are referred to using the same reference numbers as used in FIG. 11. Diagram 1400 shows repair group 1110 with two faults. Data lane LM0_LN2[9:0] corresponding micro-bump 1402 has an open failure and data lane LM1_LN6[9:0] corresponding to micro-bump 1404 has an open failure, as well. Although these faults are shown as open failures for these lanes, these lanes could have other failures, including short failures or soft errors, as described earlier.

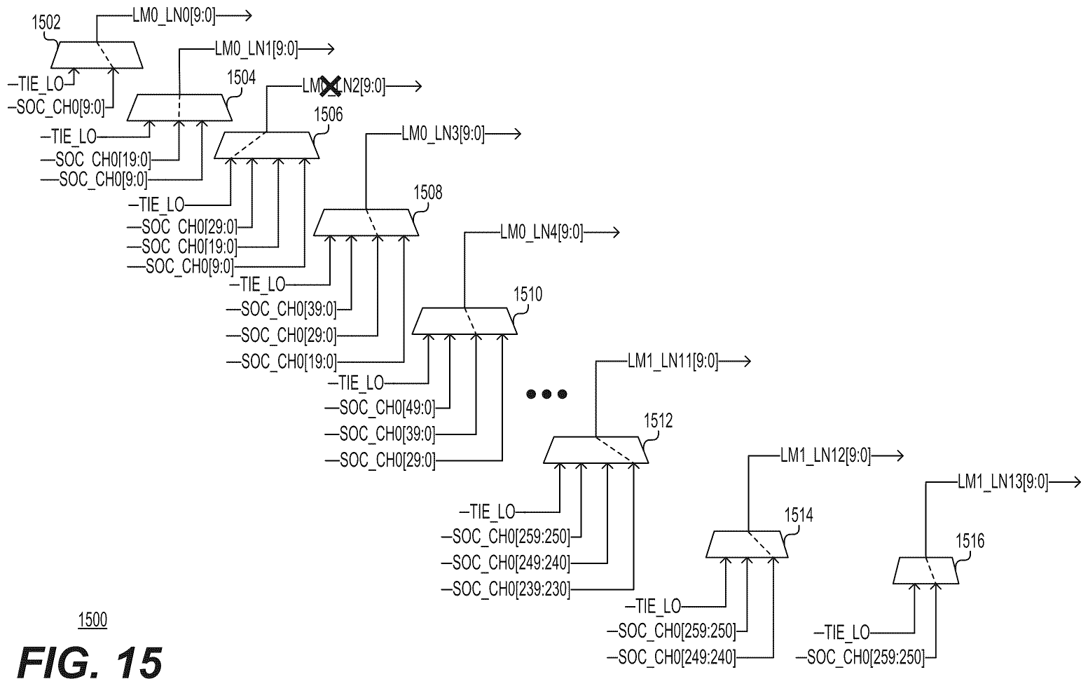

FIG. 15 shows a logical view of a transmit data path 1500, which corresponds to transmit data path 1200 of FIG. 12. Transmit data path 1500 shows which input of the several inputs to each multiplexer is being coupled (via dotted lines) to the output to illustrate the die-to-die lane repair. In this manner, FIG. 15 shows one die-to-die lane repair configuration that one could implement using the methods described herein. Other configurations could also be implemented at design time (and possibly in the field) by changing the register-transfer level (RTL) code for the transmit data path 1100 of FIG. 11 into a different configuration. As explained earlier with respect to FIG. 3, the implemented configuration is stored as part of a read only memory (e.g., ROM 324 of FIG. 3). The repair control logic (e.g., repair control logic 322 of FIG. 3) associated with the D2D node (e.g., D2D node 320) can read information stored in a read only memory (e.g., ROM 324) and store the information in CSR 326 when the SoC powers up. During initialization of the D2D nodes, repair control logic can output control signals to respective multiplexers (e.g., the ones shown as part of the transmit data path and the receive data path) in order to configure die-to-die lane repair in accordance with the information retrieved from the pertinent register (e.g., CSR 326 of FIG. 3). Transmit data path 1500 is shown with several multiplexers, including multiplexers 1502, 1504, 1506, 1508, and 1510 that correspond to the data lanes associated with a link macro identified as LM0. In addition, the transmit data path is shown with multiplexers 1512, 1514, and 1516 that correspond to the data lanes associated with another link macro identified as LM1. Each of the multiplexers has an input identified as TIE_LO, which is an input that can be used to transmit a known and fixed pattern (e.g., all zeros) through a lane that has been identified as needing repair, and has been repaired by using a redundant lane. In addition, each of the multiplexers is shown as having one to four inputs corresponding to the SoC channel data, where each input has 10 bits, which can be carried as data by a respective data lane associated with the link macro (e.g., data lane LM0_LN0[9:0] can carry either the data corresponding to the TIE_LO input or the data corresponding to the SOC_CH0[9:0] input).

With continued reference to FIG. 15, the multiplexers included in the transmit data path 1500 are shown with a dotted line to indicate the input being coupled to the output of a respective multiplexer. In this example, multiplexer 1502 has been configured to couple the input SOC_CH0[9:0] to lane LM0_LN0[9:0]. Multiplexer 1504 has been configured to couple the input SOC_CH0[19:0] to lane LM0_LN1[9:0]. Since lane LM0_LN2[9:0] requires repair, as indicated by the fault in FIG. 14 (fault corresponding to micro-bump 1402), multiplexer 1506 has been configured to couple the input TIE_LO to lane LM0_LN1[9:0]. This way, a known and fixed pattern (e.g., all zeros) is being coupled to the defective lane, which is ignored by the receive path. This means that the data being received from SOC_CH0[29:0] cannot be coupled to the faulty lane LM0_LN1[9:0]. Instead, using multiplexer 1508, the SOC_CH0[29:0] is coupled to lane LM0_LN3[9:0]. This results in the shifting of the remaining lanes to the right by one. Thus, multiplexer 1510 has been configured to couple the input SOC_CH0[39:0] to lane LM0_LN4[9:0]. Other lanes corresponding to link macro LM0 are similarly shifted to the right by one (not shown in FIG. 15).

Still referring to FIG. 15, as shown in FIG. 14, lane LM1_LN6[9:0] requires repair as well, as indicated by the fault in FIG. 14 (fault corresponding to micro-bump 1404). This means that the data being received from one of the SoC channels cannot be coupled to the faulty lane LM1_LN6[9:0]. As explained earlier, a known and fixed pattern is instead coupled to the faulty lane LM1_LN6[9:0]. This results in the shifting of the remaining lanes to the right by one (total two). Using multiplexer 1512, the SOC_CH0[239:230] is coupled to lane LM1_LN11[9:0]. Multiplexer 1514 has been configured to couple the input SOC_CH0[249:240] to lane LM1_LN12[9:0]. Multiplexer 1516 has been configured to couple the input SOC_CH0[259:250] to lane LM1_LN13[9:0]. Some of the other lanes corresponding to link macro LM1 are similarly shifted to the right by one (not shown in FIG. 15).

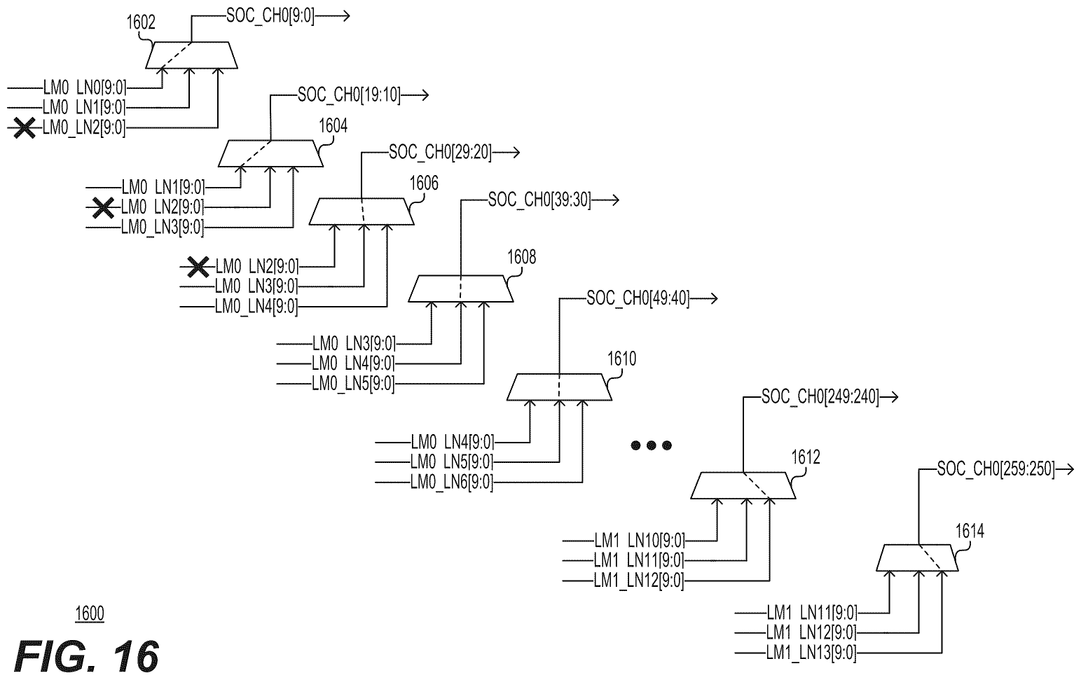

FIG. 16 shows a logical view of a receive data path 1600 for a repair group. Receive data path 1600 corresponds to the transmit data path 1500 of FIG. 15. Thus, the link macro data lanes shown in FIG. 15 carry the data, which is received by the SoC channel (SOC_CH0) shown in FIG. 14. From a logical point of view, receive data path 1600 includes several multiplexers (e.g., multiplexers 1602, 1604, 1606, 1608, and 1610 for receiving data from link macro LM0 and multiplexers 1612 and 1614 for receiving data from link macro LM1) that can be used to receive data inputs. Each of the multiplexers associated with the receive data path 1600 includes three inputs (one for each link macro data lane) and one output (one for each of the 10 bits associated with the SoC channel).

As explained earlier, the lanes are not designated as data or redundant lanes (e.g., the lanes identified as redundant lanes in FIG. 14) inside the modular link macro. Instead, a logic layer (e.g., the repair control logic and the multiplexers described earlier) associated with the modular link macro can configure the modular link macros to be able to repair a certain number of data lanes with a certain number of redundant lanes. The modular link macros, including portions of a modular link macro, can be grouped into repair groups (e.g., repair group 1110 of FIG. 11). The size of each repair group is configurable. The number of data lanes that can be repaired per repair group is configurable and can be determined or programmed on a per usage case. In one example, the number of data lanes that can be repaired is determined on a group by group basis, such that one can configure the number of data lanes that can be repaired within a group. The group size can be selected independently of the number of repair lanes. This allows a trade-off between redundant lanes and repair lanes for different groups. For example, one can choose to repair two lanes out of 20 data lanes or repair three lanes out of 24 data lanes.

Moreover, not only is the size of the repair group and the number of redundant lanes per repair group configurable, but the location of the redundant lanes within a die floor plan of a repair group is also configurable. As an example, one can choose to select the redundant lanes as the two lanes in the right hand corner of a modular link macro corresponding to a repair group, the left hand corner of the modular link macro corresponding to the repair group, or anywhere else within repair group. The die-to-die lane repair can be configurable depending on the assembly and packaging yield properties, which may change over time. Different configurations may also be chosen based on the pitch of the micro-bumps or other such interconnecting structures that are included in the modular link macros for interconnection with structures, such as interposers.

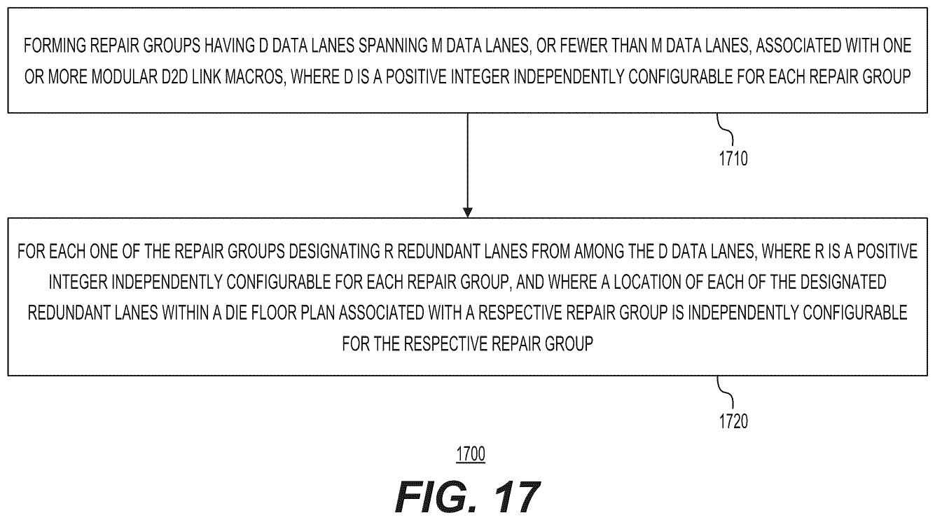

FIG. 17 shows a flowchart 1700 of a method for configuring die-to-die lane repair for lanes between a first die and a second die in a multi-die system. The first die (e.g., die 310 of FIG. 3) may comprise a first set of modular die-to-die (D2D) link macros. The second die (e.g., die 350 of FIG. 3) may comprise a second set of modular D2D link macros. Each of the first set of modular D2D link macros and the second set of modular D2D link macros may have M data lanes (e.g., 14 data lanes as shown in FIG. 4). Step 1710 includes forming repair groups having D data lanes spanning M data lanes, or fewer than M data lanes, associated with one or more modular D2D link macros, where D is a positive integer independently configurable for each repair group. As explained earlier with respect to FIGS. 9-16, the repair group size as measured in terms of the data lanes is configurable. Thus, FIG. 10 shows two different repair groups within a single die having different sizes. FIGS. 11-16 describe additional details regarding the configurability of the die-to-die lane repair. Moreover, as noted earlier, the size of the repair groups is selected based on both a use case associated with the multi-die system and packaging yield properties for the multi-die system obtained from package sorting.

Step 1720 includes for each one of the repair groups designating R redundant lanes from among the D data lanes, where R is a positive integer independently configurable for each repair group, and where a location of each of the designated redundant lanes within a die floor plan associated with a respective repair group is independently configurable for the respective repair group. As explained earlier with respect to FIGS. 9-16, the number of redundant lanes per repair group is configurable. Thus, FIG. 10 shows two different repair groups within a single die having different numbers of redundant lanes. Moreover, as noted earlier, the number of redundant lanes per repair group is selected based on both a use case associated with the multi-die system and packaging yield properties for the multi-die system obtained from package sorting.

In conclusion, the present disclosure relates to a multi-die system including a first die comprising a first set of modular die-to-die (D2D) link macros. The multi-die system further includes a second die comprising a second set of modular D2D link macros, where each of the first set of modular D2D link macros and the second set of modular D2D link macros has M data lanes, and where M is a positive integer.

The multi-die system may further include repair control logic within the multi-die system: (1) to enable formation of repair groups having D data lanes spanning M, or fewer than M, data lanes associated with one or more modular D2D link macros, where D is a positive integer independently configurable for each repair group, and (2) for each one of the repair groups, to enable designation of R redundant lanes from among the D data lanes, where R is a positive integer independently configurable for each repair group, and where a location of each of the designated redundant lanes within a die floor plan associated with a respective repair group is independently configurable for the respective repair group.

The first die may further comprise a read only memory (ROM) for storing information regarding the designated redundant lanes for each repair group. The first die may further comprise a control and status register (CSR). During at least powering up of the first die, the repair control logic may be configured to transfer the information regarding the designated redundant lanes for each repair group from the ROM to the CSR.

As part of the multi-die system, the second die may further comprise a second CSR. During at least powering up of the second die, the repair control logic is configured to transfer the information regarding the designated redundant lanes for each repair group from the ROM within the first die or a second ROM within the second die. The repair control logic may be configured to manage multiplexers associated with a transmit path for each of the M data lanes for a respective repair group.

Each of the multiplexers may include an input for receiving a fixed pattern. The input for receiving the fixed pattern can be selectively coupled to an output of a respective multiplexer. Each of the first set of modular D2D link macros and the second set of modular D2D link macros may further comprise C clock lanes. The repair control logic may be configurable to repair both data lanes and clock lanes for open failures, short failures, or soft errors.

In another example, the present disclosure relates to a method for configuring die-to-die lane repair for a multi-die system having a first die coupled with a second die. The first die may comprise a first set of modular die-to-die (D2D) link macros and the second die may comprise a second set of modular D2D link macros, where each of the first set of modular D2D link macros and the second set of modular D2D link macros has M data lanes, and where M is a positive integer.

The method may include forming repair groups having D data lanes spanning M data lanes, or fewer than M data lanes, associated with one or more modular D2D link macros, where D is a positive integer independently configurable for each repair group. The method may further include for each one of the repair groups designating R redundant lanes from among the D data lanes, where R is a positive integer independently configurable for each repair group, and where a location of each of the designated redundant lanes within a die floor plan associated with a respective repair group is independently configurable.

The first die may further comprise a read only memory (ROM) for storing information regarding the designated redundant lanes for each repair group. The first die may further comprise a control and status register (CSR). The method may further comprise during at least powering up of the first die, transferring the information regarding the designated redundant lanes for each repair group from the ROM to the CSR.

Moreover, the second die may further comprise a second CSR. The method may further comprise during at least powering up of the second die, transferring the information regarding the designated redundant lanes for each repair group from the ROM within the first die or a second ROM within the second die. The method may further include managing multiplexers associated with a transmit path for each of the M data lanes for a respective repair group. Each of the multiplexers may include an input for receiving a fixed pattern, where the input for receiving the fixed pattern can be selectively coupled to an output of a respective multiplexer.

Each of the first set of modular D2D link macros and the second set of modular D2D link macros may further comprise C clock lanes. The repair control logic may be configurable to repair both data lanes and clock lanes for open failures, short failures, or soft errors. As part of this method, configuring the die-to-die lane repair may comprise performing register-transfer level (RTL) updates for the first die and the second die.

In yet another example, the present disclosure relates to a method for configuring die-to-die lane repair for lanes between a first die and a second die in a multi-die system. The first die may comprise a first set of modular die-to-die (D2D) link macros. The second die comprises a second set of modular D2D link macros. Each of the first set of modular D2D link macros and the second set of modular D2D link macros has M data lanes, where M is a positive integer.

The method may include forming repair groups having D data lanes spanning M data lanes, or fewer than M data lanes, associated with one or more modular D2D link macros, where D is a positive integer independently configurable for each repair group, and where D is selected based on both a use case associated with the multi-die system and packaging yield properties for the multi-die system obtained from package sorting. The method may further include for each one of the repair groups designating R redundant lanes from among the D data lanes, where R is a positive integer independently configurable for each repair group, where R is selected based on both the use case associated with the multi-die system and the packaging yield properties for the multi-die system obtained from package sorting, and where a location of each of the designated redundant lanes within a die floor plan associated with a respective repair group is independently configurable.

The first die may further comprise a read only memory (ROM) for storing information regarding the designated redundant lanes for each repair group. The first die may further comprise a control and status register (CSR). The method may further comprise during at least powering up of the first die, transferring the information regarding the designated redundant lanes for each repair group from the ROM to the CSR.

Moreover, the second die may further comprise a second CSR. The method may further comprise during at least powering up of the second die, transferring the information regarding the designated redundant lanes for each repair group from the ROM within the first die or a second ROM within the second die.

The method may further include managing multiplexers associated with a transmit path for each of the M data lanes for a respective repair group. Each of the multiplexers may include an input for receiving a fixed pattern, where the input for receiving the fixed pattern can be selectively coupled to an output of a respective multiplexer.

Each of the first set of modular D2D link macros and the second set of modular D2D link macros may further comprise C clock lanes. The repair control logic may be configurable to repair both data lanes and clock lanes for open failures, short failures, or soft errors.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media, include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A multi-die system comprising:
a first die comprising a first set of modular die-to-die (D2D) link macros;
a second die comprising a second set of modular D2D link macros, wherein each of the first set of modular D2D link macros and the second set of modular D2D link macros has M data lanes, and wherein M is a positive integer; and
repair control logic within the multi-die system: (1) to enable formation of repair groups having D data lanes spanning M, or fewer than M, data lanes associated with one or more modular D2D link macros, wherein D is a positive integer independently configurable for each repair group, and (2) for each one of the repair groups, to enable designation of R redundant lanes from among the D data lanes, wherein R is a positive integer independently configurable for each repair group, and wherein a location of each of the designated redundant lanes within a die floor plan associated with a respective repair group is independently configurable for the respective repair group.

2. The multi-die system of claim 1, wherein at least the first die further comprises a read only memory (ROM) for storing information regarding the designated redundant lanes for each repair group.

3. The multi-die system of claim 1, wherein at least the first die further comprises a control and status register (CSR), and wherein during at least powering up of the first die, the repair control logic is configured to transfer the information regarding the designated redundant lanes for each repair group from the ROM to the CSR.

4. The multi-die system of claim 3, wherein the second die comprises a second CSR, and wherein during at least powering up of the second die, the repair control logic is configured to transfer the information regarding the designated redundant lanes for each repair group from the ROM within the first die or a second ROM within the second die.

5. The multi-die system of claim 1, wherein the repair control logic is configured to manage multiplexers associated with a transmit path for each of the M data lanes for a respective repair group.

6. The multi-die system of claim 1, wherein each of the multiplexers includes an input for receiving a fixed pattern, and wherein the input for receiving the fixed pattern can be selectively coupled to an output of a respective multiplexer.

7. The multi-die system of claim 1, wherein each of the first set of modular D2D link macros and the second set of modular D2D link macros further comprises C clock lanes, and wherein the repair control logic is configurable to repair both data lanes and clock lanes for open failures, short failures, or soft errors.

8. A method for configuring die-to-die lane repair for a multi-die system having a first die coupled with a second die, wherein the first die comprises a first set of modular die-to-die (D2D) link macros and the second die comprises a second set of modular D2D link macros, wherein each of the first set of modular D2D link macros and the second set of modular D2D link macros has M data lanes, and wherein M is a positive integer, the method comprising:
forming repair groups having D data lanes spanning M data lanes, or fewer than M data lanes, associated with one or more modular D2D link macros, wherein D is a positive integer independently configurable for each repair group; and
for each one of the repair groups designating R redundant lanes from among the D data lanes, wherein R is a positive integer independently configurable for each repair group, and wherein a location of each of the designated redundant lanes within a die floor plan associated with a respective repair group is independently configurable.

9. The method of claim 8, wherein at least the first die further comprises a read only memory (ROM) for storing information regarding the designated redundant lanes for each repair group.

10. The method of claim 9, wherein at least the first die further comprises a control and status register (CSR), and wherein the method further comprises: during at least powering up of the first die, transferring the information regarding the designated redundant lanes for each repair group from the ROM to the CSR.

11. The method of claim 10, wherein the second die comprises a second CSR, and wherein the method further comprises: during at least powering up of the second die, transferring the information regarding the designated redundant lanes for each repair group from the ROM within the first die or a second ROM within the second die.

12. The method of claim 9, further comprising managing multiplexers associated with a transmit path for each of the M data lanes for a respective repair group, wherein each of the multiplexers includes an input for receiving a fixed pattern, and wherein the input for receiving the fixed pattern can be selectively coupled to an output of a respective multiplexer.

13. The method of claim 8, wherein each of the first set of modular D2D link macros and the second set of modular D2D link macros further comprises C clock lanes, and wherein the repair control logic is configurable to repair both data lanes and clock lanes for open failures, short failures, or soft errors.

14. The method of claim 8, wherein configuring the die-to-die lane repair comprises performing register-transfer level (RTL) updates for the first die and the second die.

15. A method for configuring die-to-die lane repair for lanes between a first die and a second die in a multi-die system, wherein the first die comprises a first set of modular die-to-die (D2D) link macros and the second die comprises a second set of modular D2D link macros, wherein each of the first set of modular D2D link macros and the second set of modular D2D link macros has M data lanes, and wherein M is a positive integer, the method comprising:
forming repair groups having D data lanes spanning M data lanes, or fewer than M data lanes, associated with one or more modular D2D link macros, wherein D is a positive integer independently configurable for each repair group, and wherein D is selected based on both a use case associated with the multi-die system and packaging yield properties for the multi-die system obtained from package sorting; and
for each one of the repair groups designating R redundant lanes from among the D data lanes, wherein R is a positive integer independently configurable for each repair group, wherein R is selected based on both the use case associated with the multi-die system and the packaging yield properties for the multi-die system obtained from package sorting, and wherein a location of each of the designated redundant lanes within a die floor plan associated with a respective repair group is independently configurable.

16. The method of claim 15, wherein at least the first die further comprises a read only memory (ROM) for storing information regarding the designated redundant lanes for each repair group.

17. The method of claim 16, wherein at least the first die further comprises a control and status register (CSR), and wherein the method further comprises: during at least powering up of the first die, transferring the information regarding the designated redundant lanes for each repair group from the ROM to the CSR.

18. The method of claim 16, wherein the second die comprises a second CSR, and wherein the method further comprises: during at least powering up of the second die, transferring the information regarding the designated redundant lanes for each repair group from the ROM within the first die or a second ROM within the second die.

19. The method of claim 15, further comprising managing multiplexers associated with a transmit path for each of the M data lanes for a respective repair group, wherein each of the multiplexers includes an input for receiving a fixed pattern, and wherein the input for receiving the fixed pattern can be selectively coupled to an output of a respective multiplexer.

20. The method of claim 15, wherein each of the first set of modular D2D link macros and the second set of modular D2D link macros further comprises C clock lanes, and wherein the repair control logic is configurable to repair both data lanes and clock lanes for open failures, short failures, or soft errors.
